(19) United States
(12) Patent Application Publication
(10) Pub. No.: US 2006/0090608 A1
(43) Pub. Date: May 4, 2006

(54) Torque-indicating socket wrench control mechanism

(76) Inventor: Chen-Chang Tsai, Yun Lin Hsien (TW)

Correspondence Address: LEONG C LEI, PMB # 1008, 1867 YGNACIO VALLEY ROAD, WALNUT CREEK, CA, 94598, US

(21) Appl. No.: 10/975,459

(22) Filed: Oct. 29, 2004

(51) Int. Cl. B25B 13/46

(52) U.S. Cl. 81/59.1; 81/62

(57) ABSTRACT

A torque-indicating socket wrench control mechanism to provide safe, high efficient, and high strength torque operation by preventing accidental falling off or out of control due to improperly use of external force is essentially by having a primary control to plunge a the socket at a proper angle by dialing a rotation part to drive the primary control to displace by rotation when an auxiliary positioning lever being pushed in by a spring to lock to an end of a wing retainer for assuring of an effective positioning of one-way retaining thus to select the torque direction desired for transmission for the handle of the wrench.

### BACKGROUND OF THE INVENTION

(a) Technical Field of the Invention

The present invention is related to a torque-indicating socket wrench control mechanism, and more particularly to one gives safe, high efficiency, and high strength torque control.

(b) Description of the Prior Art

Socket wrenches generally available in the market are generally classified into two types, ratchet and roller. The ratchet type operates on having an inner rotor having a serrated surface adapted with a control mechanism comprised of left and right retainers, spring and rotor, primary control and box of the wrench. However, the major flaw of the ratchet type socket wrench is that it is prevented from operating in a very limited space for being subject to the angle of the serration. As for the roller type socket wrench operates on a simple construction of socket, roller and inner rotor. Wherein, pits and steel beads are provided on the rotor and pressure spring being provided to work with those pits. However, the roller type socket wrench is vulnerable to become out of control thus to cause injury to the user when subject to improperly or excessively applied external force. Furthermore, the simple construction often results in poor torque and strength to fail the exact control of torque. Therefore, either the ratchet or the roller type of socket wrench fails to meet the design requirements of high torque, high strength, and minute working space today.

### SUMMARY OF THE INVENTION

The primary purpose of the present invention is to provide an effective control mechanism for a torque-indicating socket wrench that is capable of safe, high efficiency, high strength torque control while eliminating the problem of losing control due to improperly applied external force. To achieve the purpose, a rotor when dialed drives a primary control to displace by rotation for the primary control to plunge against the socket to revolve at a proper angle; an auxiliary positioning lever at the same time is locked to the end of a wing retainer as pushed in by a spring to ensure of effective positioning of one-way retaining; and the user may firmly select the torque direction of transmission desired for the handle of the socket wrench.

Another primary purpose of the present invention is to provide an effective control mechanism for a torque-indicating socket wrench that achieves the force application on the socket wrench without being restricted by the angle, displacement by rotation, and distance of the torque indication. To achieve the purpose, a resistance interface device comprised of socket, roller and elastic member is held in position to link the operation of the inner rotor and the handle.

Yet another purpose of the present invention is to provide an effective control mechanism for a torque-indicating socket wrench that prevents failure of the torque control. To achieve the purpose, the auxiliary positioning lever effectively contains the socket after the socket rotates to fend off abnormal falling off position by the spring compressed due to improper application of force or vibration from external source to ensure the solid control of the direction and positioning of the force applied.

Still another purpose of the present invention is to provide an effective control mechanism for a torque-indicating socket wrench that prevents skid to secure effective transmission of torque. To achieve the purpose, a segment channel is provided in the box to facilitate the slide of the roller.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of a first preferred embodiment of the present invention.

FIG. 2 is a schematic view showing operation of the first preferred embodiment of the present invention in its normal positioning status.

FIG. 3 is a schematic view showing a post control in the first preferred embodiment of the present invention indicating a deflection for approximately fifteen degrees.

FIG. 4 is a schematic view showing the post control in the first preferred embodiment of the present invention indicating a deflection for approximately thirty degrees.

FIG. 5 is a perspective view of a second preferred embodiment of the present invention.

FIG. 6 is a schematic view showing operation of the second preferred embodiment of the present invention in its normal positioning status.

FIG. 7 is a schematic view showing a post control in the second preferred embodiment of the present invention indicates a deflection for approximately fifteen degrees.

FIG. 8 is a schematic view showing the post control in the second preferred embodiment of the present invention indicates a deflection for approximately thirty degrees.

FIG. 9 is a schematic view showing the arrangement of members of the present invention in use.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

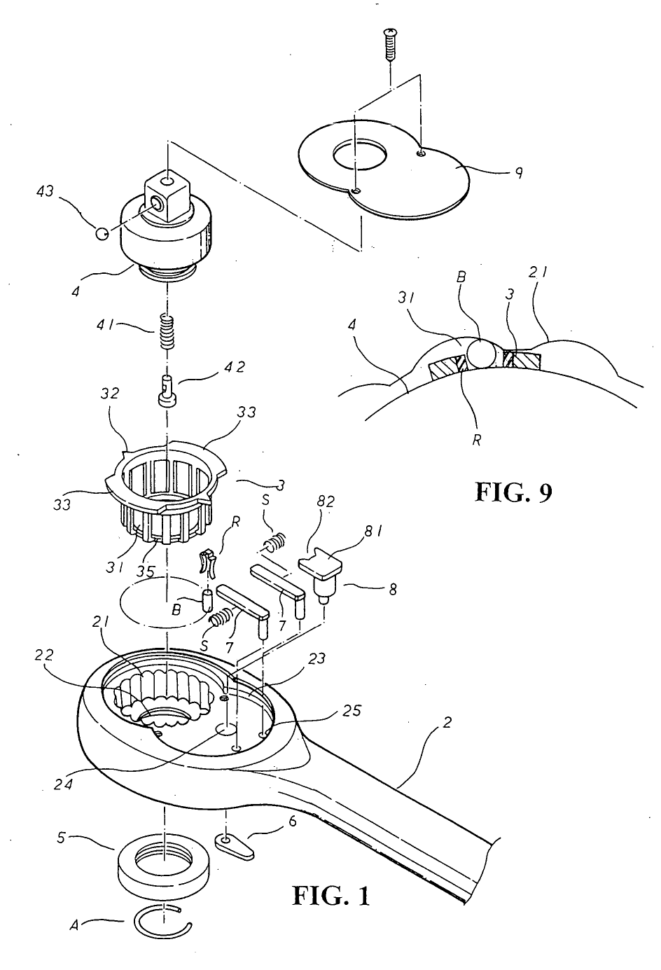

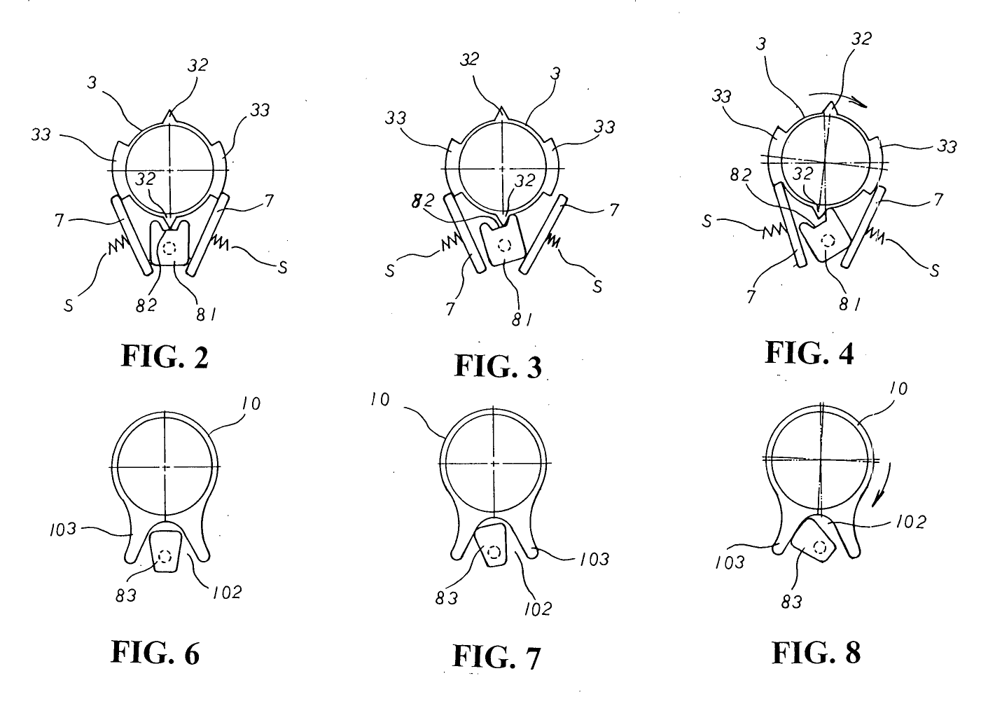

Referring to the accompanying drawings, a first preferred embodiment of the present invention is essentially comprised of a handle 2, a socket 3, an inner rotor 4, a C-washer, a ring spacer 5, a dialer 6, an auxiliary positioning lever 7, a control 8, a spring S, a lid 9, a roller B and an elastic member R. Wherein, one or multiple segment channel 21 is provided to one box of the handle 2 to accommodate the socket 3 and the inner rotor 4. One or multiple resilient member R and one or multiple roller B is fixed to the socket 3 in relation to the operation of the segment channel 21. A fillister 22 disposed at the bottom of the box of the handle 2 including the C-washer A and the ring spacer 5 contains the rotation of the inner rotor 4. On larger locking hole 23 and multiple smaller locking holes 25 are provided on a recessed surface 23 below the fillister 22 of the box of the handle 2 to house the control 9, a left and a right auxiliary positioning levers 7, and the spring S. The bottom of the control 8 is fixed to the dialer and locked in position by means of the lid 9 in a contour similar to that of the recessed surface 23. One or multiple segregation channel 31 is provided on the lower section of the socket and multiple ribs are arranged vertically into a ring adapted at their lower ends a reinforced ring 35, and at their upper ends a ring comprised of two serrated sections 32 facing each other and each provided with a tip, and another two wing retainers 33 facing to each other. The control 8 has a plate 81 provided at it upper end and a graded gap 82 on the distal end of the plate 81 in corresponding to the tip of the serrated section 32. Both of the left and the right auxiliary positioning levers 7 are pushed by the spring S to produce a force to compress in so that the tip of each auxiliary positioning lever 7 merely rests upon the outer edge of the wing retainer 33 as illustrated in FIGS. 1 and 4 in normal positioning status. Accordingly, the socket 3, the roller B, and the elastic member R execute the resistance interface linkage between the inner rotor 4 and the segment channel 21 as illustrated in FIG. 9 so to provide effective linkage of high torque and torque indication operation for the segment channel 21 to rotate and travel along with the inner rotor 4 as driven by the externally applied force.

When the handle 2 is desired to rotate clockwise, the dialer 6 is pushed in opposition direction for the plate 81 of the control 8 to deflect for approximately fifteen degrees to push away the auxiliary positioning lever 7 on the right as illustrated in FIG. 3 until the plate 81 deflects for approximately thirty degrees, the graded gap 82 of the plate 81 dials the socket 3 to rotate. Meanwhile the left auxiliary positioning lever 7 merely prevents the socket 3 to travel in opposite direction when the spring S forces to push and secure in the socket 3 by locking to the end of the wing retainer 33 as illustrated in FIG. 4. Wherein, the socket is forced to only rotate clockwise to free from falling off due to improper application of external force. The roller B and the elastic member R are tightly contained by the segment channel 21 for the inner rotor 4 and incorporated into one piece with the handle to prevent relative motion between the segment channel 21 and the inner rotor 4. Accordingly, the handle 2 achieves its purpose of transmitting the torque as the inner rotor 4 rotates. The operation in reverse direction provides the handle 2 to execute the rotation in opposite direction. The return travel by the handle 2 is completed with the rotation of the inner rotor 4 in opposite direction to drive the roller B and the elastic member R to disengage from the segment channel 21. Accordingly, the inner rotor 4 is disengaged from the handle 2 to quit the synchronous rotation between the inner rotor 4 and the handle 2. Whereas the return travel will cause the wrench to idle, the effective transmission of torque is delivered.

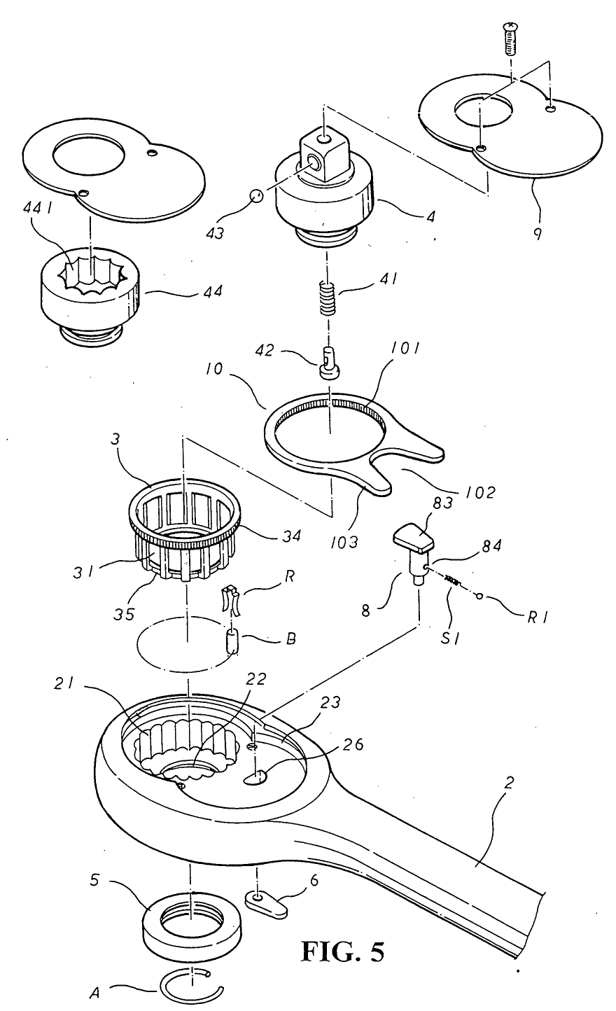

Furthermore, in the second preferred embodiment of the present invention as illustrated in FIG. 5, the outer circumference 34 of the socket 3 is serrated to engage with a serrated inner circumference 101 of a horseshoe shape spacer 10. Two retainers 103 extending from one side of the spacer 10 define a gap 102. The larger hole 24 in the first preferred embodiment is changed to a locking hole 26 in arc adapted with another type of control 8. The control has a trapezoid top plate 83 and the body of the control 8 is provided with a hole 84 containing a smaller spring S1 and a steel bead R1 to provide powerful positioning result. Accordingly, the control 8 produces compression upon both retainers 103 in relation to the rotation by the dialer 6; and finally, the spacer 10 provides the its positioning feature when the center of the spacer 10 through the retainer 103, the trapezoid plate 83 of the control 8 to the center of the control 8 define the optimal positioning location of ninety degrees as illustrated in FIGS. 5 and 6. Wherein, a clearance is reserved between the peripheral of the plate 83 and the gap 102 in normal status. When the handle 2 is desired to rotate clockwise, the dialer 6 must be first pushed in opposite direction for the control 8 when deflected for approximately fifteen degrees will have the front end of its top plate 83 to contact the retainers 103 as illustrated in FIG. 7; and when the control 8 is deflected for approximately thirty degrees, the tip of the plate 83 while dialing to move the spacer 10 drives the socket 3 to rotate for achieving the optimal location at ninety degrees. Meanwhile, the smaller spring S1 and steel beard R1 provide their positioning feature to merely maintain effective positioning and stopping the socket to rotate in opposite direction for displacement, thus to prevent from losing control due to the improperly applied external force as illustrated in FIG. 8 since the socket is allowed to rotate in positive direction only.

The roller B and the elastic member R are tightly contained by the segment channel 21 for the inner rotor 4 and incorporated into one piece with the handle to prevent relative motion between the segment channel 21 and the inner rotor 4. Accordingly, the handle 2 achieves its purpose of transmitting the torque as the inner rotor 4 rotates. The operation in reverse direction provides the handle 2 to execute the rotation in opposite direction. The return travel by the handle 2 is completed with the rotation of the inner rotor 4 in opposite direction to drive the roller B and the elastic member R to disengage from the segment channel 21. Accordingly, the inner rotor 4 is disengaged from the handle 2 to quit the synchronous rotation between the inner rotor 4 and the handle 2. Whereas the return travel will cause the wrench to idle, the effective transmission of torque is delivered.

Furthermore, a dice on the upper part of the inner rotor 4 containing a spring 41, a steel bead 43, and an escape switch 42 is removed and replaced with another inner rotor 44 containing a channel 441 in a geometric form of an arc segment, tetragon, hexagon, octagon, or dodecagon to meet the insertion of various types of parts for the torque control.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A control mechanism for a torque-indicating socket wrench is essentially comprised of handle, socket, inner rotor, C-washer, ring spacer, dialer, left and right auxiliary positioning levers, control, spring, lid, roller, and elastic member; wherein, one box of the handle including a segment channel to accommodate the socket and the inner rotor; the socket includes one or multiple elastic member and one or multiple roller in relation to the segment channel; the C-clamp and the ring spacer being confined on a recessed surface at the bottom of the box of the handle; multiple locking holes being provided on the recessed surface of the box of the handle for the installation of both of the left and the right auxiliary positioning levers and the spring; another end of the bottom of the control being fixed to the dialer by means of the lid in a contour similar to that of the recessed surface on the box of the handle and screws; one or multiple segregation channel being provided to the lower section of the socket; multiple ribs being arranged vertically into a ring adapted at their lower ends a reinforced ring, the reinforced ring being an optional item depending on the demand of the structural strength; two serrated sections facing each other and each provided with a tip and another two wing retainers facing to each other being provided on the top of those ribs in relation to the trapezoid gap of the serrated sections without contacting each other in normal status; both auxiliary positioning levers being plunged against by the spring to produce compression; the end of each auxiliary positioning lever merely resting on the outer edge of the wing retain on top of the socket in normal positioning status; the dialer being pushed to drive the control to deflect to push away the auxiliary positioning lever and to push the socket to rotate; the inner rotor including a dice at the top, a cylindrical body; the dice containing steel bead, spring and escape switch; the inner rotor rotates in opposite direction to the retaining position; and a linkage of resistance interface being produced among the elastic member, roller and socket, and the handle to provide safe, reliable, high efficiency, and high torque of torque-indicating operation angle.

2. The control mechanism for a torque-indicating socket wrench as claimed in claim 1, wherein, the present invention is adapted to a handle from a socket wrench in any configuration including a socket wrench and a torque wrench, and to a control mechanism of any product operating on torque indicating function for providing comprehensive operation benefits.

3. The control mechanism for a torque-indicating socket wrench as claimed in claim 1, wherein, the socket being provided with a serrated outer circumference to engage with a spacer for positioning purpose; two retainers being extended from one side of the spacer to define a gap; the larger locking hole on the recessed surface of the box of the handle being converted into an arc hole adapted with another type of control; the control having a trapezoid top plate; and the body of the control being provided with a channel to contain a smaller spring and steel bead.

4. The control mechanism for a torque-indicating socket wrench, as claimed in claim 1, wherein, the inner rotor is made in another type of configuration containing a channel in the form of an arc segment, tetragon, hexagon, octagon, dodecagon or any other geometric form.

5. The control mechanism for a torque-indicating socket wrench as claimed in claim 1, wherein, the resistance interface application provided by the reinforced ring and the elastic is omitted from the socket.

6. The control mechanism for a torque-indicating socket wrench as claimed in claim 1, wherein, the elastic member is made of any material and in any shape as applicable.
